(19) United States
(12) Patent Application Publication
(10) Pub. No.: US 2026/0064255 A1
(43) Pub. Date: Mar. 5, 2026

(54) METHOD FOR CREATING A GENOGRAM USING TOUCH AND VOICE INPUT

(71) Applicant: National Applied Research Laboratories, Taipei (TW)

(72) Inventors: Ming-Jen WANG, Taichung City (TW); Chia-Chen KUO, Taichung City (TW); Chia-Yung JUI, Taichung City (TW); Yi-Siang LIAO, Taichung City (TW); Han-Ye JI, Taichung City (TW)

(21) Appl. No.: 19/074,565

(22) Filed: Mar. 10, 2025

(30) Foreign Application Priority Data
Aug. 28, 2024 (TW) 113132337

(51) Int. Cl. G06F 3/04845; G06F 3/04817; G06F 3/0488; G06T 11/20; G10L 15/183; G10L 15/22; G10L 15/30

(52) U.S. Cl. CPC G06F 3/04845; G06F 3/04817; G06F 3/0488; G06T 11/26; G10L 15/183; G10L 15/22; G10L 15/30; G06T 2200/24

(57) ABSTRACT

A method for creating a genogram of a family using touch and voice input includes: in response to a user touching a part of a touchscreen, generating a touch signal indicating a set of coordinates on the touchscreen at which a touch action occurred; recording a voice input from the user, the voice input including speech describing the family; obtaining an input text that is converted from the voice input; obtaining, using a generative language model based on a content of the input text, a genogram dataset in a format that is for generating the genogram; transforming the genogram dataset into a graphical genogram dataset; and creating the genogram based on the graphical genogram dataset, using the set of coordinates as a reference point, the genogram including at least one icon representing a member of the family.

### CROSS-REFERENCE TO RELATED APPLICATION

This application claims priority to Taiwanese Invention Patent Application No. 113132337, filed on Aug. 28, 2024, the entire disclosure of which is incorporated by reference herein.

### FIELD

The disclosure relates to a method for creating a genogram, and more particularly to a method for creating a genogram using touch and voice input.

### BACKGROUND

A genogram is a graphical representation of a number of people within a family hierarchy, displaying relationships among the people. Conventionally, genograms may be created using tools that can be executed on personal computers. For example, a number of genogram templates are available to be opened and edited using Microsoft® Word, which provides a graphical user interface (GUI) for a user to edit the genogram template they chose to create a genogram.

In editing the genogram templates, it is noted that a relatively large number of symbols are provided to indicate different people and various relationships. For example, an unborn child may be represented using a triangle, a person whose gender is unknown may be represented using a rhombus, etc. However, it may be too complicated for an inexperienced person to correctly edit the genogram template to create a genogram; thus, there is room for improvement.

### SUMMARY

Therefore, an object of the disclosure is to provide a method that enables a user to create a genogram with relative ease.

According to one embodiment of the disclosure, the method for creating a genogram of a family using touch and voice input is implemented using an electronic device that includes a touchscreen, and a cloud server that is in communication with the electronic device. The method includes:
a) in response to a user touching a part of the touchscreen, detecting a touch action and generating a touch signal indicating a first set of coordinates on the touchscreen at which the touch action occurred;
b) activating a recording module of the electronic device to record a first voice input from the user, the first voice input including speech describing the family;
c) obtaining a first input text that is converted from the first voice input;
d) obtaining, using a generative language model based on a content of the first input text, a first genogram dataset in a format that is for generating the genogram;
e) transforming the first genogram dataset into a first graphical genogram dataset; and
f) creating a part of the genogram based on the first graphical genogram dataset, using the first set of coordinates as a reference point, the part of the genogram including at least one icon representing a member of the family.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating an electronic device for creating a genogram according to one embodiment of the disclosure.

FIG. 2 is a block diagram illustrating a process flow among different components of the electronic device and a cloud server according to one embodiment of the disclosure.

FIG. 3 is a flow chart illustrating steps of a method for creating a genogram for a family according to one embodiment of the disclosure.

FIG. 4 illustrates an exemplary graphical user interface (GUI) after a user has touched a part of a touchscreen.

FIG. 5 illustrates an exemplary GUI while a recording module is recording a first voice input from the user.

FIG. 6 illustrates an exemplary GUI showing the first voice input being transmitted via a communication unit to the cloud server.

FIG. 7 illustrates an exemplary GUI showing a first genogram dataset being converted as a part of a genogram.

FIG. 8 illustrates an exemplary GUI after the user has touched a first icon of the part of the genogram.

FIG. 9 illustrates an exemplary GUI showing a second genogram dataset being converted as another part of the genogram.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

Throughout the disclosure, the term “coupled to” or “connected to” may refer to a direct connection among a plurality of electrical apparatus/devices/equipment via an electrically conductive material (e.g., an electrical wire), or an indirect connection between two electrical apparatus/devices/equipment via another one or more apparatus/devices/equipment, or wireless communication.

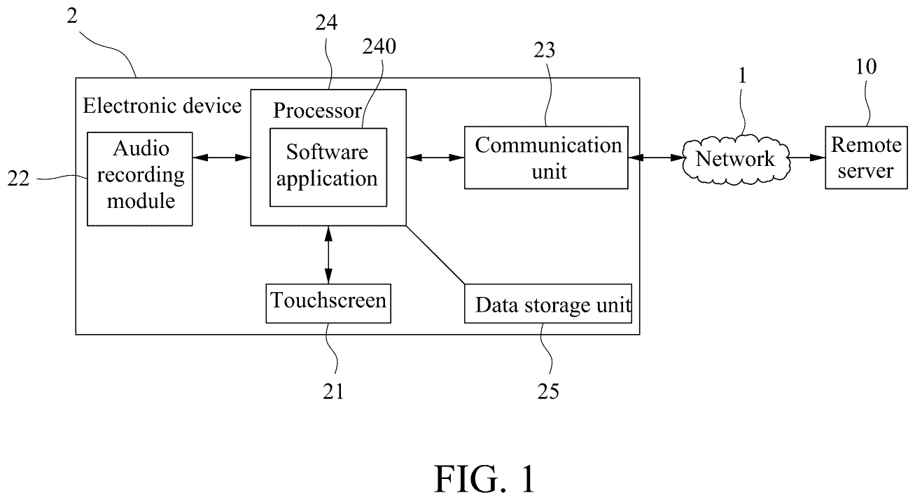

FIG. 1 is a block diagram illustrating an electronic device 2 for creating a genogram according to one embodiment of the disclosure. In this embodiment, the electronic device 2 has network connecting capacities, and may be embodied using a smartphone, a laptop, etc.

The electronic device 2 includes a touchscreen 21, an audio recording module 22, a communication unit 23 and a processor 24.

The touchscreen 21 is configured to display images thereon, and may be enabled to receive a user input touch action (using, for example, a finger, a stylus pen, etc.).

The audio recording module 22 may be embodied using components built in the electronic device 2, such as a microphone and a software application. In use, the audio recording module 22 is configured to record a voice command spoken by a user, and to generate a voice signal.

The communication unit 23 may include one or more of a radio-frequency integrated circuit (RFIC), a short-range wireless communication module supporting a short-range wireless communication network using a wireless technology of Bluetooth® and/or Wi-Fi, etc., and a mobile communication module supporting telecommunication using Long-Term Evolution (LTE), the third generation (3G) of, the fourth generation (4G) of or the fifth generation (5G) of wireless mobile telecommunications technology, or the like. The communication unit 23 enables the electronic device 2 to communicate, via a network 1 (e.g., a cloud network), with a remote server 10 such as a cloud server.

The processor 24 is connected to the touchscreen 21, the audio recording module 22, and the communication unit 23, and may be embodied using one or more of a central processing unit (CPU), a microprocessor, a microcontroller, a single core processor, a multi-core processor, a dual-core mobile processor, a microprocessor, a microcontroller, a digital signal processor (DSP), a field-programmable gate array (FPGA), an application-specific integrated circuit (ASIC), a radio-frequency integrated circuit (RFIC), etc.

In some embodiments, the processor 24 is configured to execute a software application 240 to implement the operations as described below. The software application 240 may be stored in a data storage unit 25 or in a memory module built in the processor 24, and includes a number of software modules each including instructions that, when executed by the processor 24, cause the processor 24 to execute specific operations. The data storage unit 25 is connected to the processor 24, and may be embodied using, for example, one or more of random access memory (RAM), read only memory (ROM), programmable ROM (PROM), firmware, flash memory, etc.

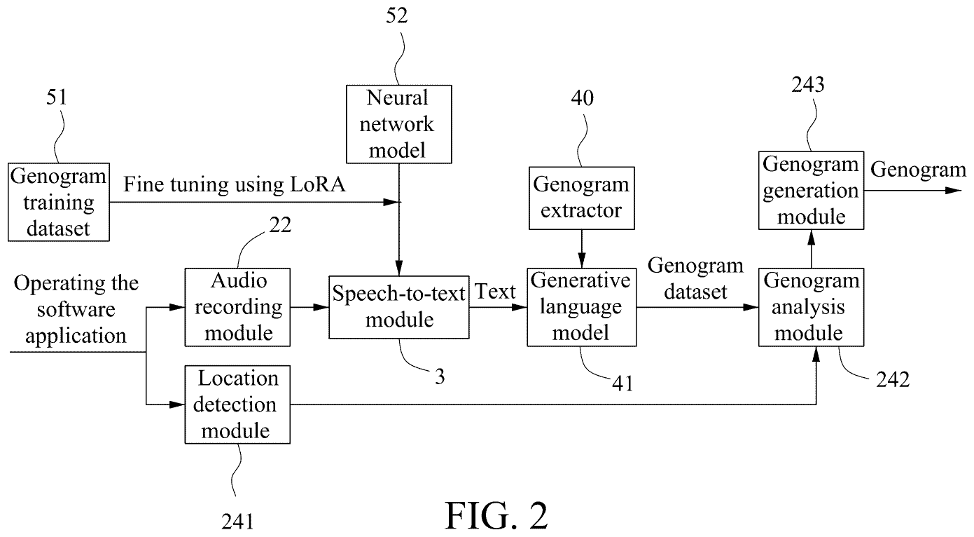

In this embodiment, the software modules include a location detection module 241, a genogram analysis module 242, a genogram generation module 243, a speech-to-text module 3, a genogram extractor 40, a generative language model 41 that operates based on information of the genogram extractor 40, etc. (see FIG. 2)

FIG. 2 is a block diagram illustrating a process flow among different components of the electronic device 2 and the remote server 10 according to one embodiment of the disclosure.

It is noted that in some embodiments, the location detection module 241, the genogram analysis module 242 and the genogram generation module 243 are integrated in the software application 240, and the speech-to-text module 3, the genogram extractor 40, and the generative language model 41 are software modules installed in the remote server 10 that can be accessed via the network 1, but other configurations may be also implemented. In embodiments, the generative language model 41 may be embodied using Large Language Model Meta AI (LLaMA).

The speech-to-text module 3 may be embodied using a commercially available software, and may alternatively be implemented using a neural network model 52 (e.g., the Whisper speech recognition system created by OpenAI) that is pre-trained using a genogram training dataset 51. In use, the training of the neural network model 52 includes a fine-tuning operation using the Low-Rank Adaptation (LoRA) technique.

The genogram extractor 40 may include a number of predetermined prompts (i.e., specific texts to be sent to the generative language model 41 so as to generate a response) for causing the generative language model 41 to perform certain actions, and prior to use, an installation process may be done to store the number of predetermined prompts in the genogram extractor 40.

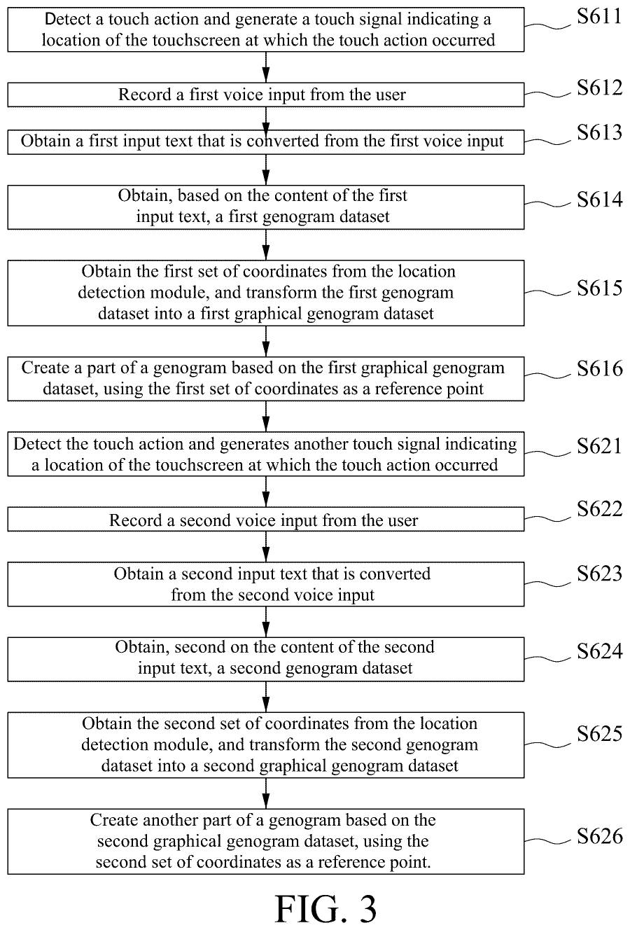

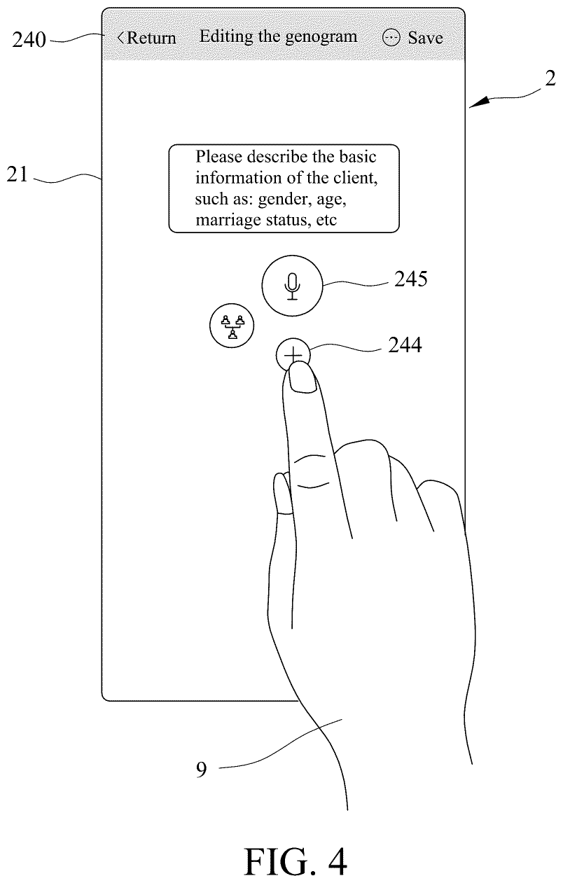

FIG. 3 is a flow chart illustrating steps of a method for creating a genogram for a family according to one embodiment of the disclosure. In this embodiment, the method is implemented using the electronic device 2 communicating with the network 1. Specifically, a user 9 (who may be a government employee or a social worker, see FIG. 4) may operate the electronic device 2 on behalf of a client. In other cases, the client may operate the electronic device 2 by himself/herself.

In actual use, after the software application 240 is executed, the processor 24 controls the touchscreen 21 to display a graphic user interface (GUI) thereon, so as to instruct the user 9 to first touch a part of the touchscreen 21 as an origin of a genogram. Generally, the GUI may include a blank area for letting the user touch any locations thereof.

In step S611, in response to the user 9 touching a part of the touchscreen 21, the location detection module 241 detects a touch action and generates a touch signal indicating a location of the touchscreen 21 at which the touch action occurred. In this embodiment, a first set of coordinates 244 (see FIG. 4) is obtained to represent the location of the touchscreen 21 at which the touch action occurred. The processor 24 then controls the GUI to display a record button 245 (see FIG. 4) and an instruction to instruct the user 9 to orally describe one member of the family. FIG. 4 illustrates an exemplary GUI after the user 9 has touched a part of the touchscreen 21. The instruction may be in the form of the text of “Please describe the basic information of the client, such as: gender, age, marriage status, etc.”

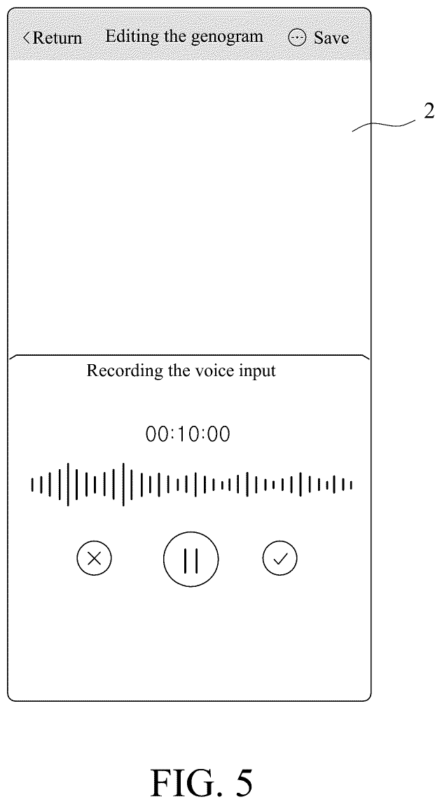

In response to the user 9 touching the record button 245, in step S612, the processor 24 activates the audio recording module 22 to record a first voice input from the user 9. Generally, the first voice input includes speech describing member(s) of the family. FIG. 5 illustrates an exemplary GUI while the recording module 22 is recording the first voice input from the user 9. In one embodiment, the first voice input may include speech of “The client is a 36-year-old male, married with his wife who is a 36-year-old female.” It is noted that “the client”in this embodiment may indicate a member of the family.

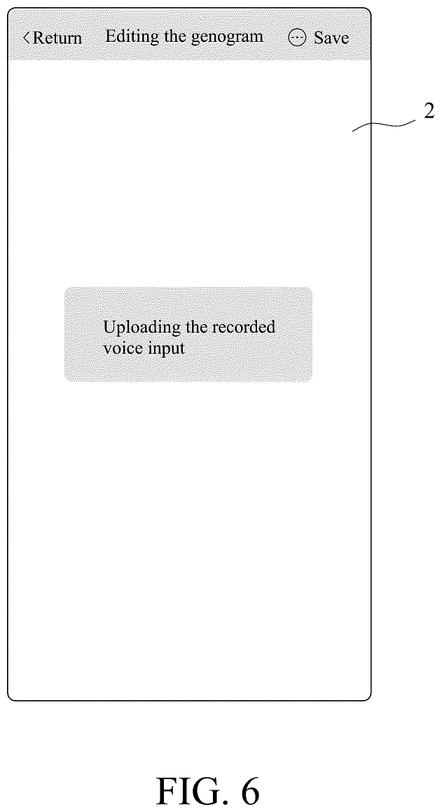

Afterwards, in step S613, the first voice input is transmitted to the speech-to-text module 3, so as to obtain a first input text that is converted from the first voice input. Generally, the first input text is also “The client is a 36-year-old male, married with his wife who is a 36-year-old female.” It is noted that in this embodiment, the first voice input is transmitted via the communication unit 23 and the network 1 to the cloud server 10, and the conversion of the first voice input is implemented by the cloud server 10 executing the speech-to-text module 3. FIG. 6 illustrates an exemplary GUI showing the first voice input being transmitted via the communication unit 23 to the cloud server 10.

Then, in step S614, the first input text is fed into the generative language model 41, so as to obtain, based on the content of the first input text, a first genogram dataset in a format that is for generating the genogram. In use, the first genogram dataset includes identification of at least one member of the family, a description of the at least one member, and a relationship of the at least one member with other member(s) of the family. The first genogram dataset may be in the format of JavaScript Object Notation (JSON). It is noted that the operation of step S614 may be done by the genogram extractor 40 sending, an input prompt that is related to one of the number of predetermined prompts stored in the genogram extractor 40 and that includes the first input text, to the generative language model 41, and the input prompt may be in the form of “Please generate a JSON dataset based on the following text ‘The client is a 36-year-old male, married with his wife who is a 36-year-old female.’” In response, the generative language model 41 generates the first genogram dataset as a reply.

Using the above example, the “The client is a 36-year-old male, married with his wife who is a 36-year-old female.” may be processed by the generative language model 41 to obtain the first genogram dataset that includes two members of the family (a male and a female), descriptions (both are 36 years old), and a relationship between the members (married). The first genogram dataset is then transmitted back to the electronic device 2.

In response to the receipt of the first genogram dataset, in step S615, the processor 24 controls the genogram analysis module 242 to obtain the first set of coordinates 244 from the location detection module 241, and transforms the first genogram dataset into a first graphical genogram dataset. The first graphical genogram dataset may be generated based on a set of predetermined definitions of graphical representations for different identities.

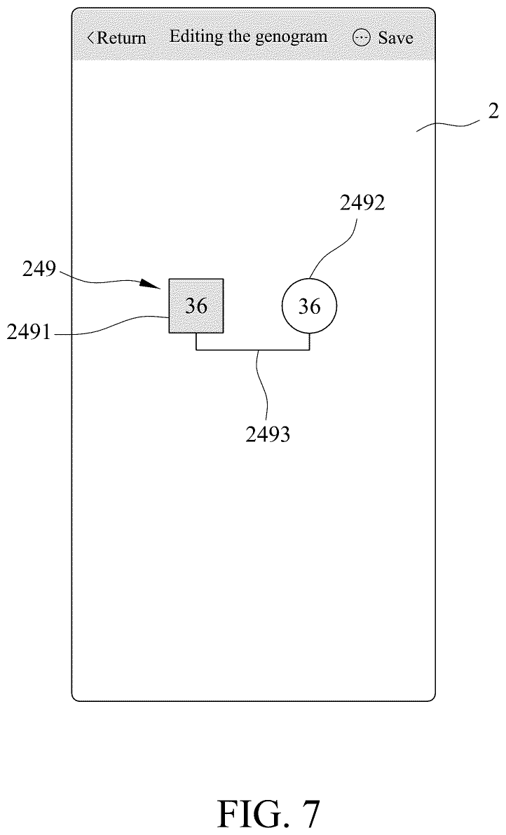

Then, in step S616, the processor 24 controls the genogram generation module 243 to create a part of a genogram based on the first graphical genogram dataset, using the first set of coordinates 244 as a reference point. FIG. 7 illustrates an exemplary GUI showing the first genogram dataset being converted as a part of a genogram 249. The part of the genogram 249 includes a first icon 2491, a second icon 2492 and a connecting line 2493. Specifically, in one exemplary first graphical genogram dataset, the first icon 2491, which indicates the “client”, is a square representing a male, and has a number (36) inside the square representing the age of the client. The second icon 2492, which indicates the wife, is a circle representing a female, and has a number (36) inside the circle representing the age of the wife. The first icon 2491 is located on the first set of coordinates 244, but may be located on other positions related to the first set of coordinates 244 in different embodiments. The first icon 2491 and the second icon 2492 are aligned with each other horizontally, indicating the members are in the same generation. In some embodiments, the first icon 2491 indicating the client may be represented using another color (e.g., gray as shown in FIG. 7).

The connecting line 2493 includes a horizontal segment that extends below the first icon 2491 and the second icon 2492, and two connecting segments each connecting one of the first icon 2491 and the second icon 2492 to a corresponding end of the horizontal segment. In embodiments, the specific form of the connecting line 2493 indicates the relationship between the members is “married”.

It is noted that in other embodiments, the first graphical genogram dataset may be generated using another set of predetermined definitions, and therefore different icons and/or different colors may be used to represent the same members. As such, the specific graphical representation as shown in FIG. 7 should not be deemed as limitation.

After one part of the genogram 249 is created on the touchscreen 21, the user 9 may choose to expand the genogram 249 by adding additional members elsewhere, or by adding at least one member that is related with an existing member that has been listed on the genogram 249.

In one example, the client may consider that his living parents should be included in the genogram 249. As such, the user 9 may touch the first icon 2491 to expand the genogram 249. Alternatively, the client may consider that other family members should be included in the genogram 249. As such, the user 9 may touch another location of the touchscreen 21 to expand the genogram 249.

In step S621, in response to the user 9 touching another part of the touchscreen 21, the location detection module 241 detects the touch action and generates another touch signal indicating a location of the touchscreen 21 at which the touch action occurred. In this embodiment, a second set of coordinates is obtained to represent the location of the touchscreen 21 at which the touch action occurred.

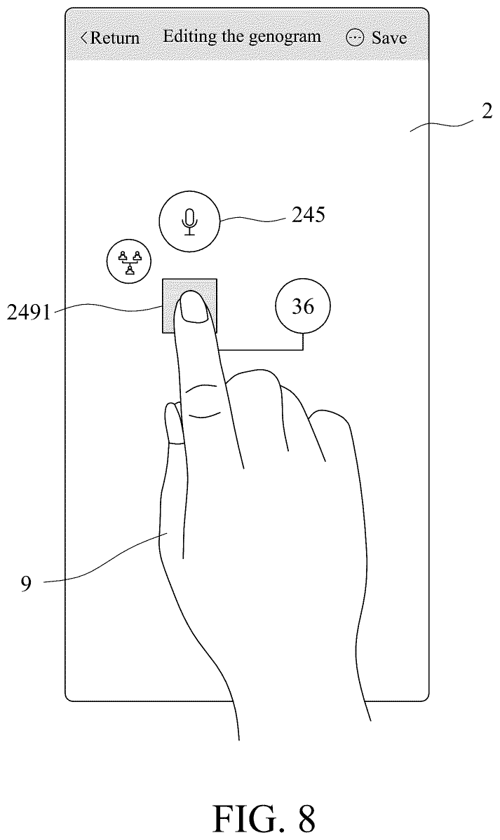

The processor 24 then controls the GUI to display the record button 245 (see FIG. 8). FIG. 8 illustrates an exemplary GUI after the user 9 has touched a part of the touchscreen 21, which is the first icon 2491. The instruction in the form of the text of “Please describe the basic information of the client, such as: gender, age, marriage status, etc.” may also be displayed.

In response to the user touching the record button 245, in step S622, the processor 24 activates the audio recording module 22 to record a second voice input from the user 9. Generally, the second voice input includes speech describing another member of the family or a person related to an existing member of the family that is already on the genogram 249. In one embodiment, the second voice input may include speech of “Both of the client's parents are living and married, the father is 69 years old, and the mother is 64 years old.”

Afterwards, in step S623, the second voice input is transmitted to the speech-to-text module 3, so as to obtain a second input text that is converted from the second voice input. Generally, the second input text is also “Both of the client's parents are living and married, the father is 69 years old, and the mother is 64 years old.” It is noted that in this embodiment, the second voice input is transmitted via the communication unit 23 and the network 1 to the cloud server 10, and the conversion of the second voice input is implemented by the cloud server 10 executing the speech-to-text module 3.

Then, in step S624, the second input text is fed into the generative language model 41, so as to obtain, based on the content of the second input text, a second genogram dataset in a format that is for generating the genogram. It is noted that the operations of step S624 may be implemented in a manner similar to those of step S614. That is, the obtaining of the second genogram dataset includes the genogram extractor 40 sending, another input prompt that is related to one of the number of predetermined prompts stored in the genogram extractor 40 and that includes the second input text, to the generative language model 41, and the generative language model 41 generating the second genogram dataset as a reply. The second genogram dataset similarly includes identification of at least one member of the family, a description of the at least one member, and a relationship of the at least one member with other member(s) of the family. The second genogram dataset may also be in the format of JSON. In one embodiment, the input prompt may be in the form of “Please generate a JSON dataset based on the following text ‘Both of the client's parents are living and married, the father is 69 years old, and the mother is 64 years old.’” In response, the generative language model 41 generates the second genogram dataset as a reply.

Using the above example, the “Both of the client's parents are living and married, the father is 69 years old, and the mother is 64 years old.” may be processed by the generative language model 41 to obtain a second genogram dataset that includes two members of the family (a male and a female), descriptions (69 and 64 years old, respectively), a relationship between the members (married), and a relationship with the existing members (being the parents of the client). The second genogram dataset is then transmitted back to the electronic device 2.

In response to the receipt of the first genogram dataset, in step S625, the processor 24 controls the genogram analysis module 242 to obtain the second set of coordinates from the location detection module 241, and transforms the second genogram dataset generated in step S624 into a second graphical genogram dataset.

Then, in step S626, the processor 24 controls the genogram generation module 243 to create another part of a genogram based on the second graphical genogram dataset, using the second set of coordinates as a reference point.

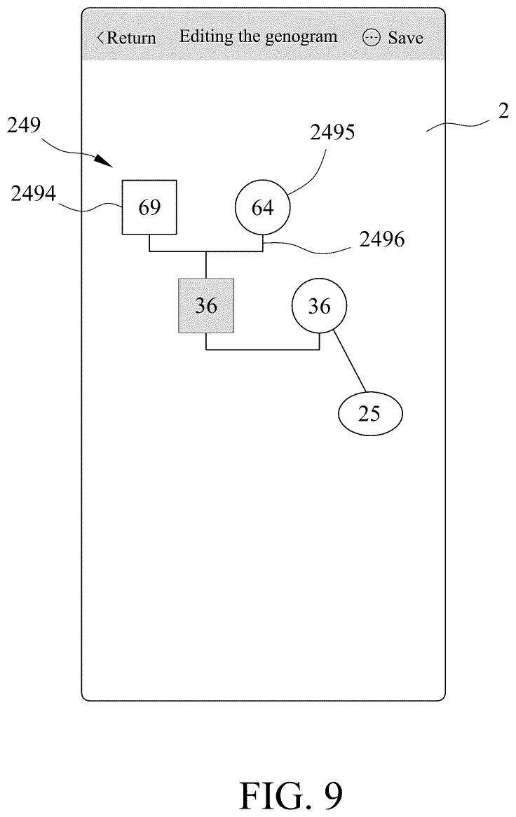

FIG. 9 illustrates an exemplary GUI showing the second genogram dataset being converted as another part of the genogram 249. In the embodiment of FIG. 9, the another part of the genogram 249 extends from the second set of coordinates. That is to say, the another part of the genogram 249 extends from one of the icons (the first icon 2491 in FIG. 8) touched by the user 9.

The another part of the genogram 249 includes a third icon 2494, a fourth icon 2495 and a connecting line 2496. The third icon 2494, which indicates the father, is a square representing a male, and has a number (69) inside the square representing the age of the father. The fourth icon 2495, which indicates the mother, is a circle representing a female, and has a number (64) inside the circle representing the age of the mother. The third icon 2494 and the fourth icon 2495 are aligned with each other horizontally and are located above the first icon 2491 and the second icon 2492, indicating the members are in the same generation and are the previous generation of the members represented by the first icon 2491 and the second icon 2492.

The connecting line 2496 includes a horizontal segment that extends below the third icon 2494 and the fourth icon 2495, and two connecting segments each connecting one of the third icon 2494 and the fourth icon 2495 to a corresponding end of the horizontal segment. In embodiments, the specific form of the connecting line 2496 indicates the relationship between the members is “married”. The connecting line 2496 further includes a vertical segment connecting the horizontal segment to the first icon 2491, indicating the parental relationship with the client.

It is noted that in some embodiments, the operations of steps S621 to S626 may be repeated to include more members so as to further expand the genogram 249 until all of the members are included, therefore completing the genogram 249.

In some examples, in addition to family members, other people related with one of the family members may be also included in the genogram 249. In one example as shown in FIG. 9, a fellow church goer related with the wife may be included in the genogram 249, and the operations of steps S621 to S626 may be repeated by first clicking on the second icon 2492, and speaking the relevant description of the fellow church goer. As a result, a fifth icon 2497 and a connecting line 2498 may be added. The fifth icon 2497 has an oval shape indicating a non-family relationship, and has a number (25) indicating that the fellow church goer is 25 years old. The connecting line 2498 may be drawn to connect diagonally the second icon 2492 and the fifth icon 2497, indicating a non-family relationship.

It is noted that during the entire operation, the user 9 generally is required to only touch a part of the touchscreen 21 and then speak the relevant description of the member.

After all of the members are included in the genogram 249, the user 9 may click the “store” button (not shown) so as to store the completed genogram 249. In some embodiments, the completed genogram 249 may be transmitted and stored in the cloud server 10. As such, the method is completed.

To sum up, the embodiments of the disclosure provide a method for creating a genogram using touch and voice input. The method includes at least the following advantages: (1) the user is enabled to create a genogram without learning to operate the conventional software that is used for creating the genogram or without memorizing what icons to use for specific members, and can simply click on the touchscreen and speak out the information needed for the genogram; as such, the genogram may be created in a very intuitive manner; (2) the method enables the user to separately create parts of the genogram and to connect the parts together to complete a more complicated genogram; (3) in addition to the family members, non-family members may be easily added to the genogram using the same technique and be represented by different icons such as ovals; and (4) the genogram extractor 40 is configured to include a list of prompts for causing the generative language model 41 to perform certain actions, and in actual use, the genogram extractor 40 is controlled to transmit an input prompt including an input text to the generative language model 41, and in response, the generative language model 41 generates the first genogram dataset based on the content of the input text. In such a manner, the manual operations for creating the genogram may be reduced to a minimum.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for creating a genogram of a family using touch and voice input, the method being implemented using an electronic device that includes a touchscreen, and a cloud server that is in communication with the electronic device, the method comprising:
a) in response to a user touching a part of the touchscreen, detecting a touch action and generating a touch signal indicating a first set of coordinates on the touchscreen at which the touch action occurred;
b) activating a recording module of the electronic device to record a first voice input from the user, the first voice input including speech describing the family;
c) obtaining a first input text that is converted from the first voice input;
d) obtaining, using a generative language model based on a content of the first input text, a first genogram dataset in a format that is for generating the genogram;
e) transforming the first genogram dataset into a first graphical genogram dataset; and
f) creating a part of the genogram based on the first graphical genogram dataset, using the first set of coordinates as a reference point, the part of the genogram including at least one icon representing a member of the family.

2. The method as claimed in claim 1, further comprising, after step f), steps of:
in response to the user touching another part of the touchscreen, detecting another touch action and generating another touch signal indicating a second set of coordinates of the touchscreen at which the touch action occurred;
activating the recording module of the electronic device to record a second voice input from the user, the second voice input including speech describing a person related to the member of the family;
obtaining a second input text that is converted from the second voice input;
obtaining, using the generative language model based on a content of the second input text, a second genogram dataset in a format that is for generating the genogram;
transforming the second genogram dataset into a second graphical genogram dataset; and
creating another part of the genogram based on the second graphical genogram dataset, using the second set of coordinates as a reference point.

3. The method as claimed in claim 2, wherein the touch action related to the user touching the another part of the touchscreen occurred on the at least one icon, and the another part of the genogram extends from the at least one icon.

4. The method as claimed in claim 2, wherein the person is another member of the family.

5. The method as claimed in claim 2, wherein the person is a non-family member, and the another part of the genogram includes another icon, which is in a shape different from that of the at least one icon.

6. The method as claimed in claim 2, wherein:
the method further comprises, prior to step a), implementing an installation process to store a number of predetermined prompts in a genogram extractor;
step d) includes the genogram extractor sending, an input prompt that is related to one of the number of predetermined prompts and that includes the first input text, to the generative language model, and the generative language model generating the first genogram dataset as a reply;
the obtaining a second genogram dataset includes the genogram extractor sending, another input prompt that is related to one of the number of predetermined prompts and that includes the second input text, to the generative language model, and the generative language model generating the second genogram dataset as a reply; and
each of the first genogram dataset and the second genogram dataset includes identification of at least one member of the family, a description of the at least one member, and a relationship of the at least one member with another member of the family.

7. The method as claimed in claim 2, wherein each of the first genogram dataset and the second genogram dataset is in the format of JavaScript Object Notation (JSON).

8. The method as claimed in claim 1, wherein:
step c) is implemented using a speech-to-text module; and
the method further comprises, prior to step a), a step of training a neural network model using a genogram training dataset to serve as the speech-to-text module.

9. The method as claimed in claim 8, wherein the neural network model is a Whisper speech recognition system.

10. The method as claimed in claim 8, wherein the training a neural network model includes a fine-tuning operation using a Low-Rank Adaptation (LoRA) technique.

11. The method as claimed in claim 1, wherein the generative language model is embodied using Large Language Model Meta AI (LLaMA).

12. The method as claimed in claim 1, the cloud server including a speech-to-text module, wherein:
step c) includes the electronic device transmitting the first voice input to the cloud server, to enable the speech-to-text module of the cloud server to convert the first voice input into the first input text.

13. The method as claimed in claim 1, the cloud server including a generative language model that operates based on information of a genogram extractor, wherein:
step d) includes the genogram extractor sending an input prompt that includes the content of the first input text to the generative language model, the generative language model generating the first genogram dataset as a reply, and the cloud server transmitting the first genogram dataset to the electronic device.
